(19) United States
(12) Patent Application Publication
(10) Pub. No.: US 2009/0293495 A1
(43) Pub. Date: Dec. 3, 2009

(54) TURBINE AIRFOIL WITH METERED COOLING CAVITY

(75) Inventors: Victor Hugo Silva Correia, Milton Hills, NH (US); Daniel Edward Demers, Ipswich, MA (US); Robert Francis Manning, Newburyport, MA (US)

Correspondence Address: TREGO, HINES & LADENHEIM, PLLC, 9300 HARRIS CORNERS PARKWAY, SUITE 210, CHARLOTTE, NC, 28269, US

(73) Assignee: General Electric Company, Schenectady, NY (US)

(21) Appl. No.: 12/129,375

(22) Filed: May 29, 2008

(51) Int. Cl. F02C 7/18; F01D 9/02

(52) U.S. Cl. 60/782; 415/115

(57) ABSTRACT

A turbine airfoil for a gas turbine engine includes: (a) spaced-apart pressure and suction sidewalls extending between a leading edge and a trailing edge; (b) a first cavity disposed between the pressure and suction sidewalls, the first cavity being adapted to be fed cooling air from a source within the engine, and connected to at least one film cooling hole which communicates with an exterior surface of the airfoil; (c) a second cavity disposed between the pressure and suction sidewalls, the second cavity being adapted to be fed cooling air from a source within the engine, and connected to at least one film cooling hole which communicates solely with the suction sidewall of the airfoil; and (d) a metering structure adapted to substantially restrict air flow into the second cavity.

### BACKGROUND OF THE INVENTION

This invention relates generally to gas turbine engine turbines and more particularly to methods for cooling turbine airfoils in such engines.

A gas turbine engine includes a turbomachinery core having a high pressure compressor, a combustor, and a high pressure turbine (HPT) in serial flow relationship. The core is operable in a known manner to generate a primary gas flow.

The HPT includes annular arrays of stationary airfoils called vanes or nozzles that direct the gases exiting the combustor into rotating airfoils called blades or buckets. Collectively one row of nozzles and one row of blades make up a “stage”. These components operate in an extremely high temperature environment, and must be cooled by air flow, typically impingement or film cooling, or a combination thereof, to ensure adequate service life. Typically, the air used for cooling is extracted from one or more points in the compressor. These bleed flows represent a loss of net work output and/or thrust to the thermodynamic cycle. They increase specific fuel consumption (SFC) and are generally to be avoided as much as possible.

Typically, an HPT nozzle airfoil has a leading edge cavity and a trailing edge cavity separated by a rib or wall. The location of this wall is positioned to reduce the overall length of airfoil panels on each cavity, to avoid ballooning stresses. In addition, the position of the wall is dependent on the location of the inner band flange, relative to the leading edge cavity break out for casting producibility. As a result the wall between the two cavities is located at or near the throat area, which is the location of minimum cross-sectional area between two adjacent nozzle airfoils. Film holes, which are used to cool the suction side of the airfoil, are typically placed upstream of the throat area so as to make the flow non-chargeable to the engine cycle, avoiding a performance penalty. The film holes are placed as close to the throat as practical, to minimize the length of suction side surface dependent on this film for cooling.

These suction side film holes discharge air into a lower pressure region of the gas path. The film hole cooling array and flow level is dependant on the pressure ratio from the supply cavity to the gas path discharge location. The supply pressure of the feed cavity is set to avoid ingestion anywhere across its wall, which is most likely to occur at the leading edge and pressure sides of the airfoil. As a result, the pressure ratio at the suction side film holes is excessively high. This results in a high flow rate per hole and a lower hole density within the array, effectively reducing cooling effectiveness.

### BRIEF SUMMARY OF THE INVENTION

These and other shortcomings of the prior art are addressed by the present invention, which provides a turbine airfoil with an internal cavity that is fed a reduced pressure cooling flow to improve film cooling effectiveness.

According to one aspect, a turbine airfoil for a gas turbine engine includes: (a) spaced-apart pressure and suction sidewalls extending between a leading edge and a trailing edge; (b) a first cavity disposed between the pressure and suction sidewalls, the first cavity being adapted to be fed cooling air from a source within the engine, and connected to at least one film cooling hole which communicates with an exterior surface of the airfoil; (c) a second cavity disposed between the pressure and suction sidewalls, the second cavity being adapted to be fed cooling air from a source within the engine, and connected to at least one film cooling hole which communicates solely with the suction sidewall of the airfoil; and (d) a metering structure adapted to substantially restrict air flow into the second cavity.

According to another aspect of the invention, a method is provided for, in a gas turbine engine, cooling a turbine nozzle having at least two spaced-apart, hollow, turbine airfoils, each of which includes: a first cavity disposed between pressure and suction sidewalls of the turbine airfoil and connected to at least one film cooling hole which communicates with an exterior surface of the airfoil; and a second cavity disposed between the pressure and suction sidewalls, and connected to at least one film cooling hole which communicates solely with the suction sidewall of the airfoil. The method includes: (a) directing cooling air from a source within the engine to each of the first cavities at a first pressure; (b) exhausting cooling air from the first cavities through the at least one film cooling hole connected thereto; (c) directing cooling air from a source within the engine to each of the second cavities; (d) dropping the pressure of the cooling air to a second pressure substantially lower than the first pressure before introducing it into each of the second cavities; and (e) exhausting cooling air from the second cavities through the at least one film cooling hole connected thereto.

According to another aspect of the invention, a turbine airfoil for a gas turbine engine includes: (a) spaced-apart pressure and suction sidewalls extending between a leading edge and a trailing edge; (b) a first cavity disposed between the pressure and suction sidewalls, the first cavity being adapted to be fed cooling air from a source within the engine, and connected to at least one film cooling hole which communicates with an exterior surface of the airfoil; (c) a second cavity disposed between the pressure and suction sidewalls, the second cavity being separated from the first cavity by a wall having at least one metering hole passing therethrough, and connected to at least one film cooling hole which communicates solely with the suction sidewall of the airfoil; and (d) a metering structure adapted to substantially restrict air flow into the second cavity.

### BRIEF DESCRIPTION OF THE DRAWINGS

The invention may be best understood by reference to the following description taken in conjunction with the accompanying drawing figures in which:

FIG. 1 a schematic cross-sectional view of a high-bypass gas turbine engine including a turbine nozzle constructed in accordance with the present invention;

FIG. 2 is a perspective view of a turbine nozzle segment constructed in accordance with an aspect of the present invention;

FIG. 3 is a view taken along lines 3-3 of FIG. 2;

FIG. 4 is another perspective view of the turbine nozzle shown in FIG. 2.

FIG. 5 is a perspective view of an alternative turbine nozzle segment constructed in accordance with an aspect of the present invention;

FIG. 6 is a view taken along lines 6-6 of FIG. 5; and

FIG. 7 is a another perspective view of the turbine nozzle shown in FIG. 5.

### DETAILED DESCRIPTION OF THE INVENTION

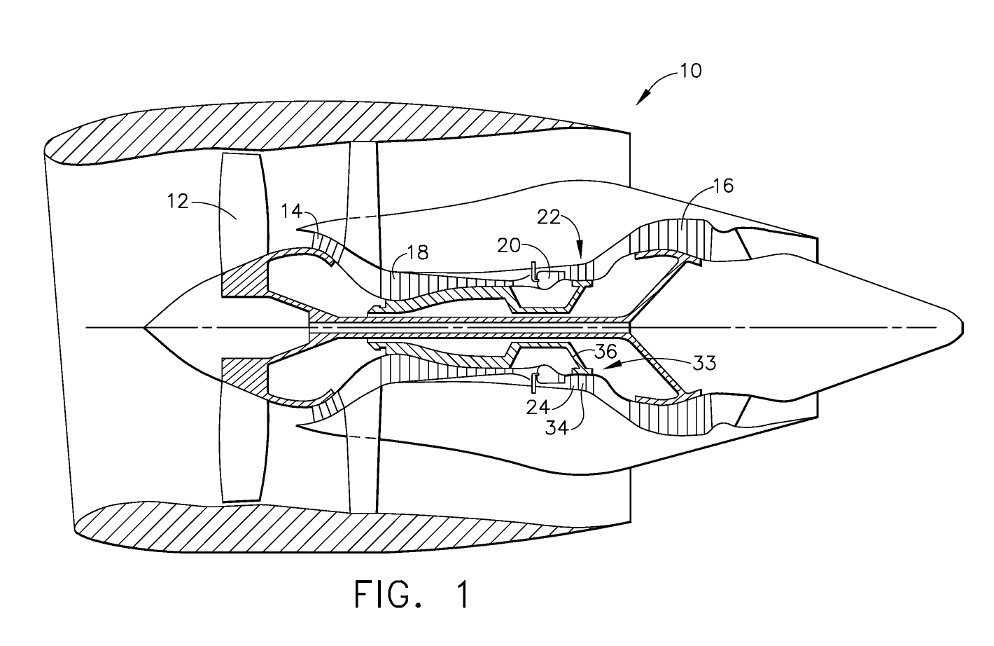

Referring to the drawings wherein identical reference numerals denote the same elements throughout the various views, FIG. 1 depicts a gas turbine engine 10 having a fan 12, a low pressure compressor or “booster” 14 and a low pressure turbine (“LPT”) 16 collectively referred to as a “low pressure system”, and a high pressure compressor (“HPC”) 18, a combustor 20, and a high pressure turbine (“HPT”) 22, collectively referred to as a “gas generator” or “core”. Together, the high and low pressure systems are operable in a known manner to generate a primary or core flow as well as a fan flow or bypass flow. While the illustrated engine 10 is a high-bypass turbofan engine, the principles described herein are equally applicable to turboprop, turbojet, and turboshaft engines, as well as turbine engines used for other vehicles or in stationary applications.

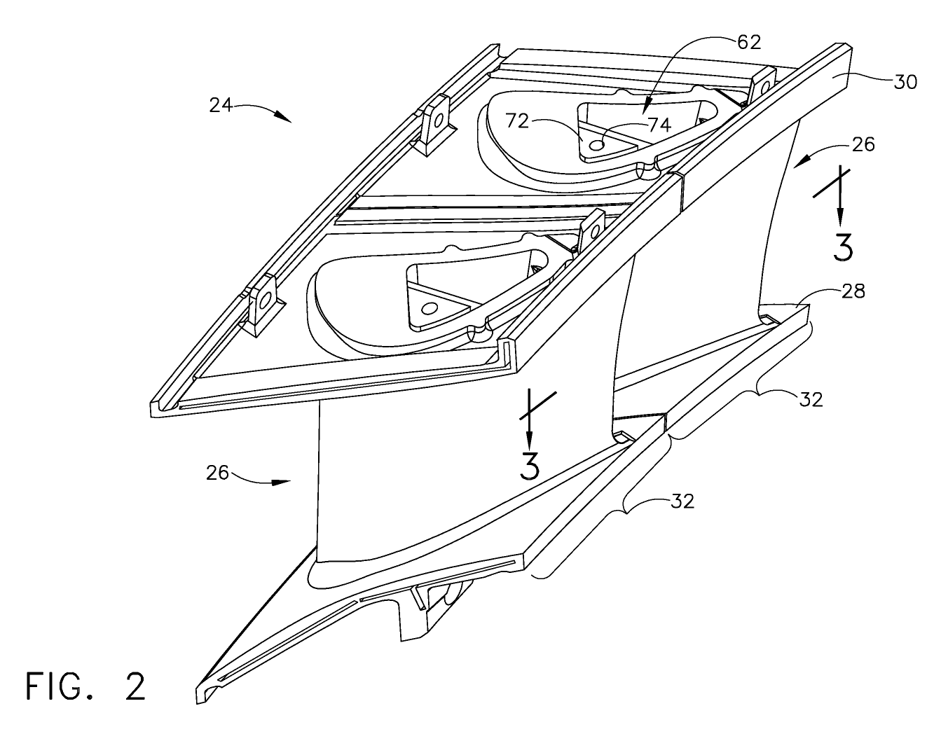

The high pressure turbine 22 includes a high pressure nozzle 24. As shown in FIG. 2, the high pressure nozzle 24 comprises an array of airfoil-shaped hollow vanes 26 that are supported between an arcuate, segmented inner band 28 and an arcuate, segmented outer band 30. The vanes 26, first inner band 28 and outer band 30 are arranged into a plurality of circumferentially adjoining nozzle segments 32 that collectively form a complete 360° assembly. In this example each of the nozzle segments 32 is a “singlet” having one vane 26, but other configurations (doublet, triplet, etc.) as well as continuous rings or half-rings are known. The inner and outer bands 28 and 30 define the outer and inner radial flowpath boundaries, respectively, for the hot gas stream flowing through the high pressure nozzle 24. The vanes 26 are configured so as to optimally direct the combustion gases to a rotor 33.

The rotor 33 includes an array of airfoil-shaped turbine blades 34 extending outwardly from a disk 36 that rotates about the centerline axis of the engine 10. In the illustrated example, the high pressure turbine 22 is of the single-stage type having a single high pressure turbine nozzle 24 and rotor 26. However, the principles of the present invention are equally applicable to multiple stage high-pressure turbines or to low-pressure turbines, where such turbines are cooled.

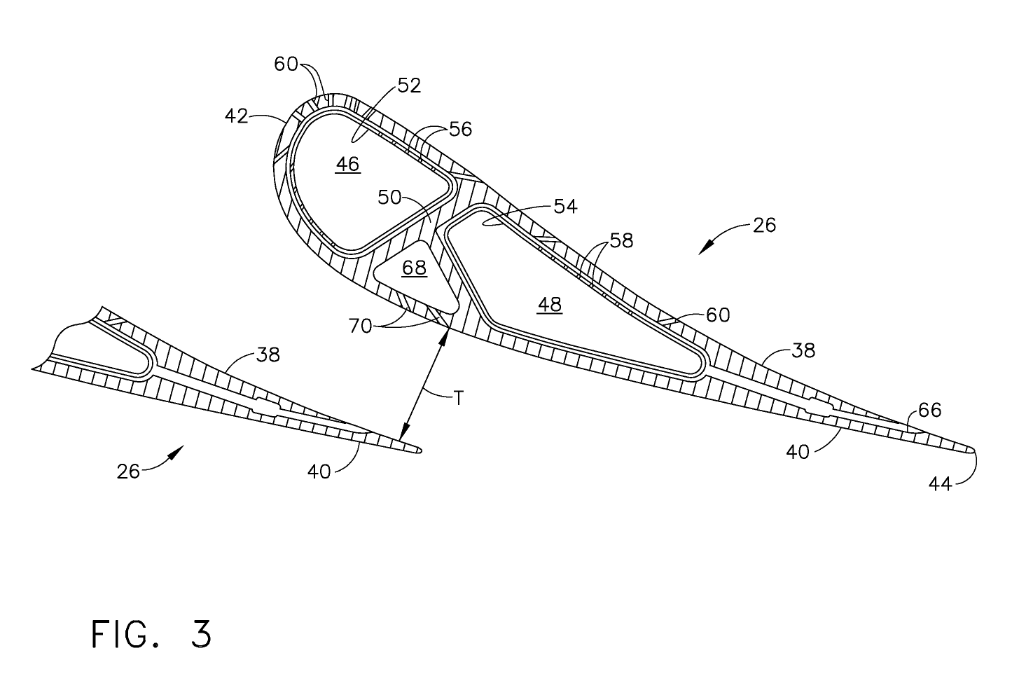

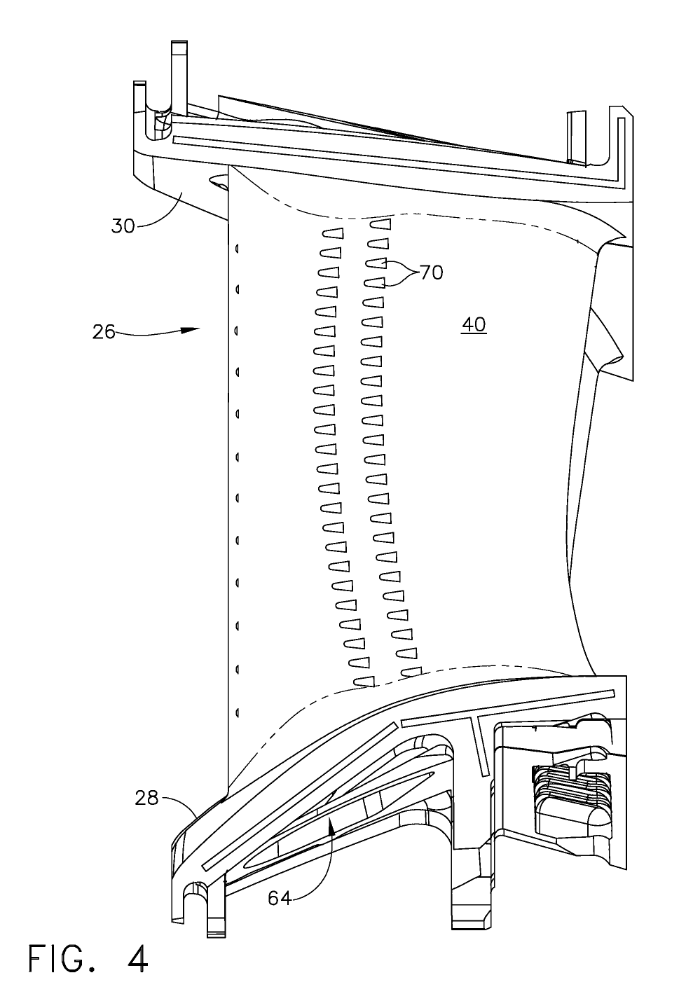

FIGS. 3 and 4 illustrate the construction of the nozzle 24 in more detail. Each vane 26 has spaced-apart pressure and suction sidewalls 38 and 40 which extend between a leading edge 42 and a trailing edge 44. The vanes 26 are arranged such that the suction sidewall 40 of a first vane 26 faces the pressure sidewall 38 of its neighboring vane 26. The location at which the cross-sectional flow area between two neighboring vanes 26 is at a minimum is referred to as a “throat”, denoted “T” in FIG. 3.

The interior of each vane 26 is generally hollow and is divided into a leading edge cavity 46 and a trailing edge cavity 48 by a rib or wall 50 integral to the vane casting. Optional impingement cooling inserts 52 and 54 of a known type pierced with impingement cooling holes 56 and 58 respectively are disposed in the leading and trailing edge cavities 46 and 48, respectively. Film cooling holes 60 formed through the pressure sidewall 38 and leading edge 42 communicate with the leading and trailing edge cavities 46 and 48. The leading and trailing edge cavities 46 and 48 may be fed cooling air from their radially inner or outer ends, or both. In this example the trailing edge cavity 48 has an inlet 62 at its radially outer end (see FIG. 2), and the leading edge cavity 46 has an inlet 64 at its radially inner end (see FIG. 4). Trailing edge cooling passages 66 such as the illustrated holes communicate with the aft end of the trailing edge cavity 48.

A metered cavity 68 is located aft of the leading edge cavity 46 and along the suction sidewall 40. A plurality of film cooling holes 70 in the suction sidewall 40 communicate with the metered cavity 68, and may have their exits located upstream of the throat T. FIG. 3 is an example of a metered cavity 68 with a generally triangular cross-sectional shape ending just aft of the throat T. However, the shape and location of the metered cavity 68 is not critical and may be varied to suit a particular application. The metered cavity 68 may be fed from its radially inner or outer end, or both. As shown in FIG. 2, the metered cavity 68 is fed from its outer end. The radially outer end of the metered cavity 68 is closed off by a metering plate 72 with a metering hole 74 formed therethrough. The metering plate 72 is coupled to a source of cooling air, such as compressor discharge pressure (CDP) air, in a known manner. The metering hole 74 is sized to reduce the pressure in the metered cavity 68 to a selected level.

In operation, pressurized cooling air is provided to the leading edge, trailing edge, and metered cavities, 46, 48, and 68. The cooling air passes into the leading edge and trailing edge cavities 46 and 48 at substantially the supply pressure. However, the cooling air flow supplied to the metered cavity 68 is restricted by the metering hole 74, reducing pressure in the metered cavity 68 to a level just sufficient to provide positive film cooling of the suction sidewall 40 with acceptable backflow margin. This selected pressure level is substantially below the pressure in the leading edge and trailing edge cavities 46 and 48. The resulting metered cavity pressure level enables the utilization of a higher density of the suction sidewall film cooling holes 70, thereby providing more effective film cooling to the suction sidewall 40. This cooling configuration provides effective cooling of the suction sidewall 40, which historically exhibits thermal distress. The result is a more efficiently cooled airfoil while using substantially the same amount of cooling flow as the prior art.

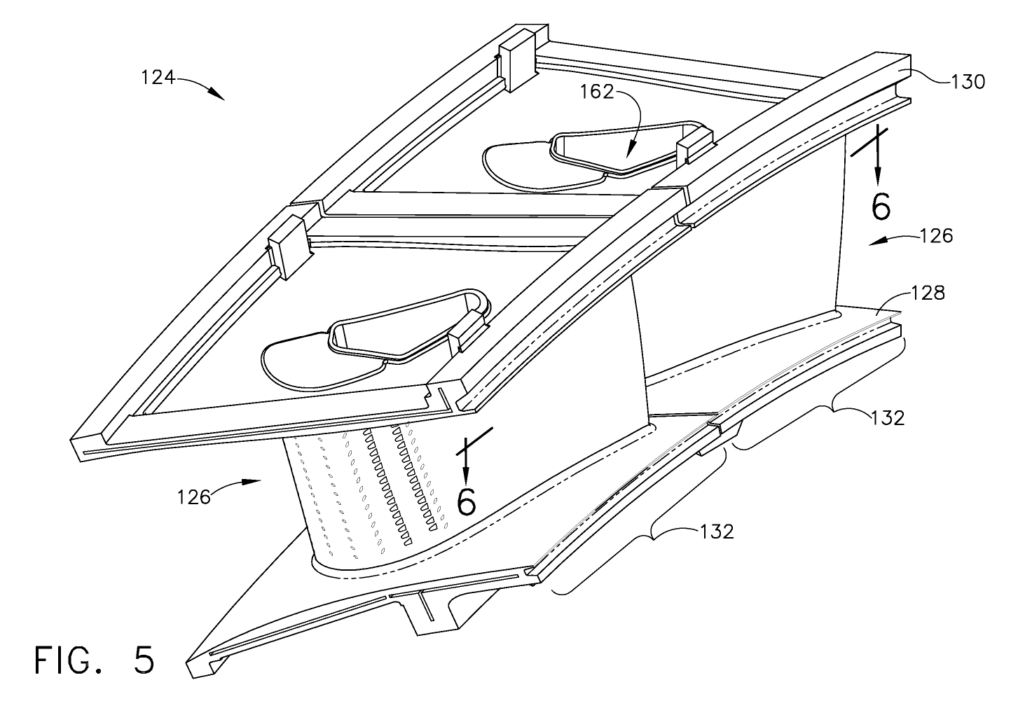

FIGS. 5-7 illustrate an alternative high pressure turbine nozzle 124. It is generally similar in construction to the high pressure nozzle 24 described above and comprises an array of airfoil-shaped hollow vanes 126, an arcuate, segmented inner band 128 and an arcuate, segmented outer band 130. The vanes 126, first inner band 128 and outer band 30 are arranged into a plurality of circumferentially adjoining “singlet” nozzle segments 132.

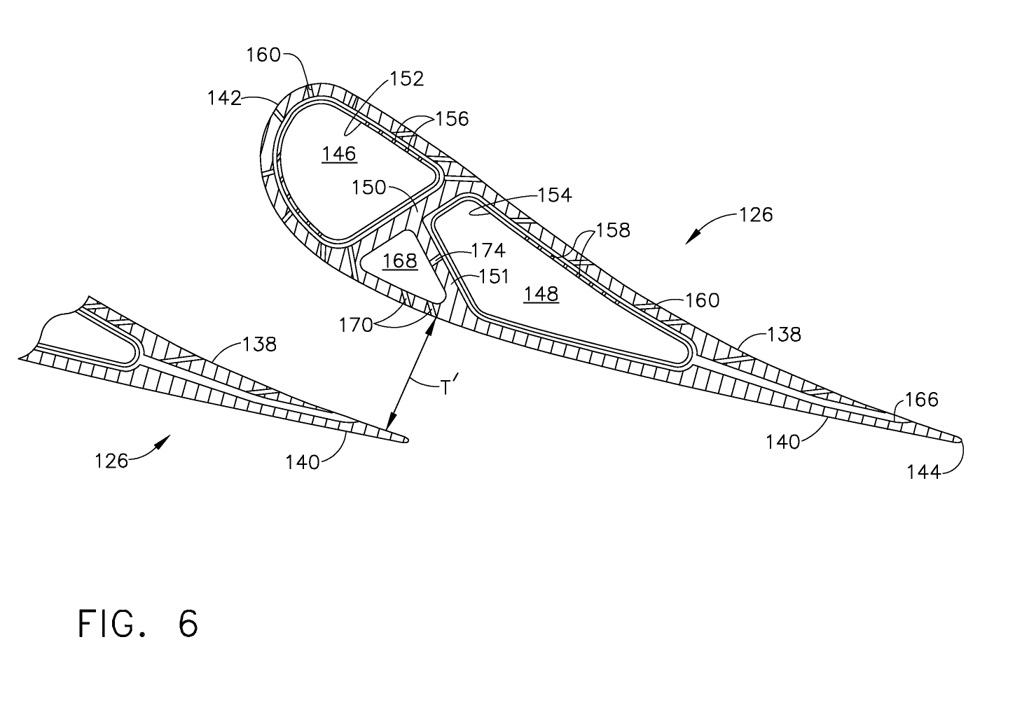

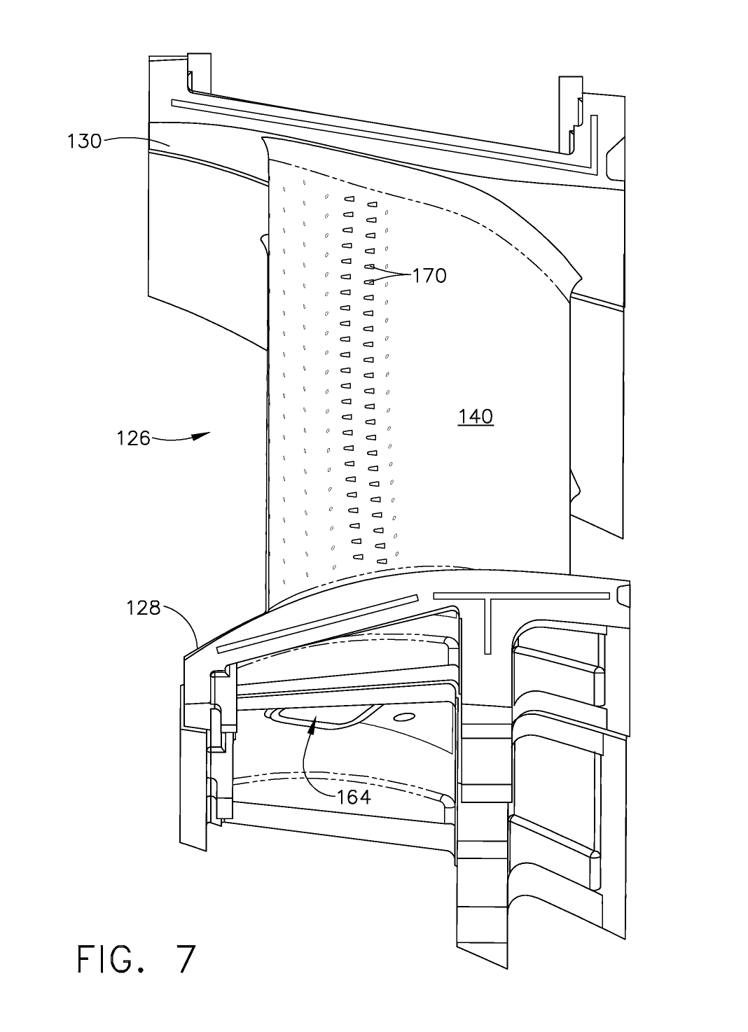

FIGS. 6 and 7 illustrate the construction of the nozzle 124 in more detail. Each vane 126 has spaced-apart pressure and suction sidewalls 138 and 140 which extend between a leading edge 142 and a trailing edge 144. The vanes 126 are arranged such that the suction sidewall 140 of a first vane 126 faces the pressure sidewall 138 of its neighboring vane 126. The location at which the cross-sectional flow area between two neighboring vanes 126 is at a minimum is referred to as a “throat”, denoted “T′” in FIG. 6.

The interior of each vane 126 is generally hollow and is divided into a leading edge cavity 146 and a trailing edge cavity 148 by a rib or wall 150 integral to the vane casting. Optional impingement cooling inserts 152 and 154 of a known type pierced with impingement cooling holes 156 and 158 respectively are disposed in the leading and trailing edge cavities 146 and 148, respectively. Film cooling holes 160 formed through the pressure sidewall 138 and leading edge 142 communicate with the leading and trailing edge cavities 146 and 148. The leading and trailing edge cavities 146 and 148 may be fed cooling air from their radially inner or outer ends, or both. In this example the trailing edge cavity 148 has an inlet 162 at its radially outer end (see FIG. 5), and the leading edge cavity 146 has an inlet 164 at its radially inner end (see FIG. 7). Trailing edge cooling passages 166 such as the illustrated holes communicate with the aft end of the trailing edge cavity 148.

A metered cavity 168 is located aft of the leading edge cavity 146 and along the suction sidewall 140. A plurality of film cooling holes 170 in the suction sidewall 140 communicate with the metered cavity 168, and may have their exits located upstream of the throat T′. FIG. 6 is an example of a metered cavity 168 defined by the wall 150 and another intersecting wall 151 and having a generally triangular cross-sectional shape ending just aft of the throat T′. The shape and location of the metered cavity 168 is not critical and may be varied to suit a particular application. The metered cavity 168 is feed by one or more metering holes 174 (only one of which is shown) formed in the intersecting wall 151, which communicate with the trailing edge cavity 148. Alternatively, the metering holes 174 could be formed through the wall 150 so as to feed the metered cavity 168 from the leading edge cavity 146. The metering holes 174 are sized to reduce the pressure in the metered cavity 68 to a selected level.

Operation of the turbine nozzle 124 is similar to that of the nozzle 24 described above. Pressurized cooling air is provided to the leading edge and trailing edge cavities 146 and 148. The cooling air passes into the leading edge and trailing edge cavities 146 and 148 at substantially the supply pressure. Some of cooling air flow passes from the trailing edge cavity 148 through the metering hole 174. The cooling air flow supplied to the metered cavity 168 is restricted by the metering hole 74, reducing pressure in the metered cavity 168 to a level just sufficient to provide positive film cooling of the suction sidewall 140 with acceptable backflow margin. This selected pressure level is substantially below the pressure in the leading edge and trailing edge cavities 146 and 148. The resulting metered cavity pressure level enables the utilization of a higher density of the suction sidewall film cooling holes 170, thereby providing more effective film cooling to the suction sidewall 140, as described above.

The foregoing has described cooling arrangements for a gas turbine engine. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. A turbine airfoil for a gas turbine engine, comprising:
(a) spaced-apart pressure and suction sidewalls extending between a leading edge and a trailing edge;
(b) a first cavity disposed between the pressure and suction sidewalls, the first cavity being adapted to be fed cooling air from a source within the engine, and connected to at least one film cooling hole which communicates with an exterior surface of the airfoil;
(c) a second cavity disposed between the pressure and suction sidewalls, the second cavity being adapted to be fed cooling air from a source within the engine, and connected to at least one film cooling hole which communicates solely with the suction sidewall of the airfoil; and
(d) a metering structure adapted to substantially restrict air flow into the second cavity.

2. The turbine airfoil of claim 1 wherein the metering structure comprises a metering plate which closes off a distal end of the second cavity, the metering plate having a metering hole formed therethrough.

3. The turbine airfoil of claim 1 wherein an insert pierced with impingement cooling holes is disposed in the first cavity.

4. The turbine airfoil of claim 1 further comprising a third cavity disposed between the pressure and suction sidewalls, the third cavity being adapted to be fed cooling air from a source within the engine, and connected to at least one film cooling hole which communicates with an exterior surface of the airfoil.

5. The turbine airfoil of claim 4 wherein an insert pierced with impingement cooling holes is disposed in the third cavity.

6. The turbine airfoil of claim 4 wherein the first cavity is disposed adjacent the trailing edge, the second cavity is disposed adjacent the suction sidewall, and the third cavity is disposed adjacent the leading edge.

7. The turbine airfoil of claim 6 wherein the first and third cavities are separated by a common wall.

8. The turbine airfoil of claim 4 wherein:
(a) the first cavity has an open radially outer end;
(b) the metering structure is disposed at a radially outer end of the second cavity; and
(c) the third cavity has an open radially inner end.

9. A turbine nozzle comprising at least two of the turbine airfoils of claim 1 disposed in spaced-apart relation between arcuate inner and outer bands.

10. The turbine nozzle of claim 9 wherein:
(a) a throat of minimal cross-sectional area is defined between the pressure sidewall of one of the airfoils and the suction sidewall of an adjacent one of the turbine airfoils; and
(b) the at least one film cooling hole connecting solely with the suction sidewall of each turbine airfoil has an exit upstream of the throat.

11. The turbine nozzle of claim 9 where the second cavity of each turbine airfoil is disposed adjacent the respective suction sidewall.

12. The turbine nozzle of claim 1 wherein the second cavity is feed cooling air from the first cavity.

13. The turbine nozzle of claim 12 wherein the metering structure comprises a wall separating the first and second cavities, the wall having a metering hole formed therethrough.

14. In a gas turbine engine, a method of cooling a turbine nozzle having at least two spaced-apart, hollow turbine airfoils, each of which includes:
a first cavity disposed between pressure and suction sidewalls of the turbine airfoil and connected to at least one film cooling hole which communicates with an exterior surface of the airfoil, and
a second cavity disposed between the pressure and suction sidewalls, and connected to at least one film cooling hole which communicates solely with the suction sidewall of the airfoil; the method comprising:
(a) directing cooling air from a source within the engine to each of the first cavities at a first pressure;
(b) exhausting cooling air from the first cavities through the at least one film cooling hole connected thereto;
(c) directing cooling air from a source within the engine to each of the second cavities;
(d) dropping the pressure of the cooling air to a second pressure substantially lower than the first pressure before introducing it into each of the second cavities; and
(e) exhausting cooling air from the second cavities through the at least one film cooling hole connected thereto.

15. The method of claim 14 wherein the pressure reduction of step (d) is carried out by passing cooling air through a metering structure adapted to substantially restrict air flow into the second cavity.

16. The method of claim 14 further comprising, before step (b), impingement cooling each of the first cavities.

17. The method of claim 14 wherein each of the turbine airfoils includes a third cavity disposed between the pressure and suction sidewalls, and connected to at least one film cooling hole which communicates with an exterior surface of the airfoil; the method further comprising:
(a) directing cooling air from a source within the engine to each of the third cavities at the first pressure; and
(b) exhausting cooling air from the third cavities through the at least one film cooling hole connected thereto.

18. The method of claim 17 further comprising, before step (b), impingement cooling each of the third cavities.

19. The method of claim 17 wherein the first cavity is disposed adjacent a trailing edge of the turbine airfoil, the second cavity is disposed adjacent the suction sidewall, and the third cavity is disposed adjacent a leading edge of the turbine airfoil.

20. The method of claim 17 wherein:
(a) cooling air is supplied to a radially outer end of the first cavity;
(b) cooling air is supplied to a radially outer end of the second cavity; and
(c) cooling air is supplied to a radially inner end of the third cavity.

21. The method of claim 14 wherein:
(a) a throat of minimal cross-sectional area is defined between the pressure sidewall of one of the airfoils and the suction sidewall of an adjacent one of the turbine airfoils; and
(b) cooling air exits the at least one film cooling hole connecting solely with the suction sidewall of each turbine airfoil at a location upstream of the throat.

22. The method of claim 14 where step (c) is carried out by passing cooling air from each of the first cavities to a corresponding one of the second cavities.

23. The method of claim 22 wherein the pressure reduction is carried out by passing cooling air through at least one metering hole in a wall separating the first and second cavities.

24. A turbine airfoil for a gas turbine engine, comprising:
(a) spaced-apart pressure and suction sidewalls extending between a leading edge and a trailing edge;
(b) a first cavity disposed between the pressure and suction sidewalls, the first cavity being adapted to be fed cooling air from a source within the engine, and connected to at least one film cooling hole which communicates with an exterior surface of the airfoil;
(c) a second cavity disposed between the pressure and suction sidewalls, the second cavity being separated from the first cavity by a wall having at least one metering hole passing therethrough, and connected to at least one film cooling hole which communicates solely with the suction sidewall of the airfoil; and
(d) a metering structure adapted to substantially restrict air flow into the second cavity.
